(19) United States
(12) Patent Application Publication
(10) Pub. No.: US 2003/0157306 A1
(43) Pub. Date: Aug. 21, 2003

(54) Binding element

(76) Inventor: Guido Frans Maria Jozef Peleman, Puurs (BE)

Correspondence Address: BACON & THOMAS, PLLC, 625 SLATERS LANE, FOURTH FLOOR, ALEXANDRIA, VA, 22314

(21) Appl. No.: 10/297,922

(22) PCT Filed: Jun. 27, 2001
(86) PCT No.: PCT/BE01/00110

(30) Foreign Application Priority Data
Jun. 28, 2000 (BE) 2000416

(51) Int. Cl. B32B 3/00

(52) U.S. Cl. 428/201; 428/212

(57) ABSTRACT

Improved binding element, characterized in that it consists of a part (1) made of metal; on this part (1), an intermediate layer (2) which is attached on the part (1) by means of a high-temperature glue (3); and on the aforementioned intermediate layer (2), a low-temperature glue (4).

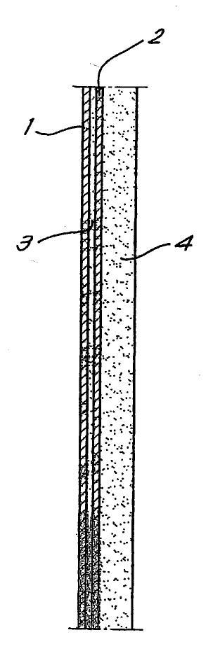

The present invention relates to an improved binding element, more particularly a binding element of the type whereby the interior of the back is provided with an amount of glue which melts under the influence of heat and whereby the intention is to apply the edges of a number of sheets or documents in this melted glue, in such a manner that, after the glue has hardened, said sheets or documents are fastened in a solid manner.

More particularly, the present invention relates to such binding element, the back of which is formed by a metal strip which either or not is folded into a certain shape and whereby said amount of glue is provided on this metal strip.

It is known that for an ideal binding of sheets, documents or the like, it must be provided for that the so-called binding glue becomes as liquid as water, such that the documents can settle into the binding glue due to their own weight, without the necessity of tapping on the documents in order to insert them into the binding glue.

In this manner, the heating of said binding glue can be stopped at a certain moment, without any other intermediary, after which cooling can take place.

Only on the basis of said conditions, one may speak of a really automatic binding.

In a particular embodiment, said back will be realized in a U-shape, whereby the meltable binding glue is provided in the base of said back.

However, an important disadvantage thereof is that the meltable binding glue does not adhere well to the hard metal back.

Thus, the present invention relates to improvements by which a perfect connection between said meltable glue or binding glue and said metal back is obtained in a simple manner.

It is known that binding glues which are provided in such aforementioned binding element or binding file are designed such and show such features that they specifically can glue paper, cardboard or such in a very good manner.

The disadvantage thereof is that these binding glues, however, do not adhere well to metal.

At the same time, it is known that the temperature of said binding glues may not exceed 130° C., as otherwise possible synthetic materials, such as PVC, PP or such, which form part of the binding element or the binding file, might be thermically damaged.

The present problem, thus, is that the binding glue, which really is very liquid below 130° C., and which glues paper, cardboard and the like in a very good manner, badly adheres to hard metal elements, such as the back of a binding element or binding file.

It is also known that said binding glues, when they glue paper, cardboard and the like in a very good manner and also adhere to metals, such as, for example, steel, in a very good manner, even above 130° C. become so little liquid that the sheets, documents or the like will not settle into the binding glue by themselves, but will have to be beaten in by tapping on these sheets, documents or the like.

According to the present invention, thus, a binding glue will be applied which is very liquid at a low temperature, in other words, below 130° C., and which, at the same time, glues paper as well as metal in a very good manner.

At the same time, the known binding glue, which becomes very liquid below 130° C., can be applied on the metal in a previous processing step, such that the adherence becomes very good.

To this aim, for example, first an intermediate layer can be provided on the metal, by means of a glue which only melts above 130° C. and which forms a good connection between metal and paper, after which a binding glue, which melts below 130° C., is provided on this intermediate layer.

Thereby, this intermediate layer can be formed of paper.

The improvements allowing the aforementioned and other advantages, substantially consist of a part consisting of metal; on this part, an intermediate layer which is adhered to this part by means of a high-temperature glue; and on said intermediate layer, a low-temperature glue 4.

With the intention of better showing the characteristics of the invention, hereafter,. as an example without any limitative character, a preferred form of embodiment of the improvements according to the invention is described, with reference to the accompanying drawing, which schematically represents the connection of sheets, documents or the like with the metal back of a binding element, binding file or the like.

In this figure, according to the invention a part 1 made of metal is provided with a layer of paper 2 which is adhered onto the strip of metal 1 by means of a glue 3 with a high melting temperature, for example, above 130° C., after which on this sheet of paper 2 the traditional binding glue 4, with a low melting temperature, for example, below 130° C., is provided.

It is obvious that any material can be chosen as an intermediate layer 2.

The present invention is in no way limited to the embodiment described as an example and represented in the drawings; on the contrary, it may be realized in a variety of forms, dimensions and compositions without leaving the scope of the invention.

1. Improved binding element, characterized in that it consists of a part (1) made of metal; on this part (1), an intermediate layer (2) which is attached on the part (1) by means of a high-temperature glue (3); and on the aforementioned intermediate layer (2), a low-temperature glue (4).

2. Improved binding element according to claim 1, characterized in that the intermediate layer (2) is fomed by a sheet of paper.

3. Improved binding element according to claim 1, characterized in that by high-temperature glue (3), a glue is understood with a melting temperature above 130° C.

4. Improved binding element according to claim 1, characterized in that by low-temperature glue (4), a glue is understood with a melting temperature below 130° C.
